(19) United States
(12) Patent Application Publication
(10) Pub. No.: US 2026/0228341 A1
(43) Pub. Date: Aug. 6, 2026

(54) PROCESSING DEVICE, PROCESSING METHOD, AND PROGRAM

(71) Applicant: NTT, INC., Tokyo (JP)

(72) Inventors: Masami IZUMI, Musashino-shi, Tokyo (JP); Keiichiro KASHIWAGI, Musashino-shi, Tokyo (JP); Kenji UMAKOSHI, Musashino-shi, Tokyo (JP)

(21) Appl. No.: 19/152,250

(22) PCT Filed: Feb. 3, 2023
(86) PCT No.: PCT/JP2023/003652

§ 371 Date: Jul. 30, 2025

(51) Int. Cl. G06F 21/57; G06F 21/53

(52) U.S. Cl. CPC G06F 21/57; G06F 21/53

(57) ABSTRACT

A processing device 1 includes a storage device that stores policy data 12 including an identifier of processing logic data 13 and an identifier of processing data 14, and a verification timing for specifying a necessity of verification before or after importing the processing logic data 13 or the processing data 14 into a trusted execution environment or before execution of the processing logic data 13, the processing logic data 13 and the processing data 14 being data to be imported into the trusted execution environment; an importing unit 21 that imports the processing logic data 13 and the processing data 14 into the trusted execution environment; and a verification unit 23 that verifies the trusted execution environment at a timing specified as the verification timing by referring to the policy data 12, and outputs report data 17 including a verification result.

### TECHNICAL FIELD

The present disclosure relates to a processing device, a processing method, and a program.

### BACKGROUND ART

There has been an increase in efforts for multiple companies to work together to solve social issues, such as the realization of a resource circulation society.

Further, data distribution between organizations that support the efforts is also starting.

There is a great concern that sensitive data or processing logic, such as know-how or trade secrets held by each organization, may be leaked after disclosure, making it impossible to achieve sufficient distribution.

Confidential computing is a technique that addresses the concern. Confidential computing creates a trusted execution environment through access control, CPU core and memory isolation, and virtualization. There is a technique that ensures integrity by utilizing data encryption in addition to a trusted execution environment (Non-Patent Literature 1).

### CITATION LIST

### Non-Patent Literature

Non-Patent Literature 1: AWS, “AWS Nitro Enclaves”, [online], [retrieved on January 20, 2023], Internet <URL: https://aws.amazon.com/jp/ec2/nitro/nitro-enclaves/>

### SUMMARY OF INVENTION

### Technical Problem

The technique described in Non-Patent Literature 1 only ensures data or logic at a timing when the trusted execution environment is generated. In order for multiple users to continuously provide data or logic, it is necessary to ensure data or logic even after the trusted execution environment is generated.

The present disclosure has been made in view of the circumstances described above, and an object of the present disclosure is to provide a technique capable of ensuring data or logic even after generation of a trusted execution environment.

### Solution to Problem

According to an aspect of the present disclosure, there is provided a processing device including: a storage device that stores policy data including an identifier of processing logic data and an identifier of processing data, and a verification timing for specifying a necessity of verification before or after importing the processing logic data or the processing data into a trusted execution environment or before execution of the processing logic data, the processing logic data and the processing data being data to be imported into the trusted execution environment; an importing unit that imports the processing logic data and the processing data into the trusted execution environment; and a verification unit that verifies the trusted execution environment at a timing specified as the verification timing by referring to the policy data, and outputs report data including a verification result.

According to another aspect of the present disclosure, there is provided a processing method causing a computer to: store policy data including an identifier of processing logic data and an identifier of processing data, and a verification timing for specifying a necessity of verification before or after importing the processing logic data or the processing data into a trusted execution environment or before execution of the processing logic data, the processing logic data and the processing data being data to be imported into the trusted execution environment; import the processing logic data and the processing data into the trusted execution environment; and verify the trusted execution environment at a timing specified as the verification timing by referring to the policy data, and output report data including a verification result.

According to still another aspect of the present disclosure, there is provided a program for causing a computer to function as the processing device.

### Advantageous Effects of Invention

According to the present disclosure, it is possible to provide a technique capable of ensuring data or logic even after generation of a trusted execution environment.

### BRIEF DESCRIPTION OF DRAWINGS

FIG. 1 is a diagram illustrating a system configuration of a processing system according to an embodiment of the present disclosure.

FIG. 2 is a diagram illustrating functional blocks of a processing device.

FIG. 3 is a diagram for explaining an example of a data structure of policy data and data.

FIG. 4 is a sequence diagram for explaining a processing method by the processing device.

FIG. 5 is a diagram for explaining importing processing by an importing unit.

FIG. 6 is a sequence diagram for explaining an example of processing in the processing system (part 1).

FIG. 7 is a sequence diagram for explaining an example of processing in the processing system (part 2).

FIG. 8 is a diagram for explaining a hardware configuration of a computer used in the processing device.

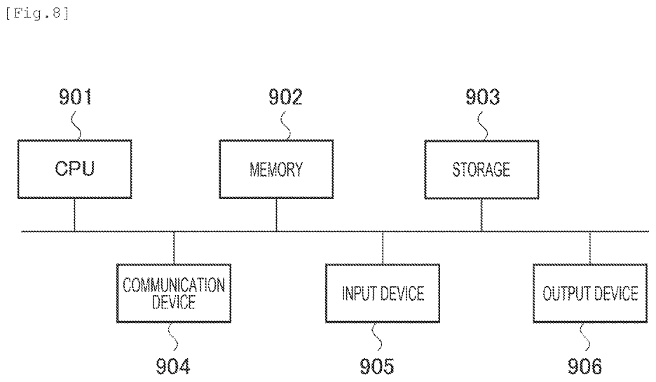

### DESCRIPTION OF EMBODIMENTS

Hereinafter, an embodiment of the present disclosure will be described with reference to the drawings. In the drawings, the same portions are denoted by the same reference signs, and description thereof is omitted.

### (Processing System)

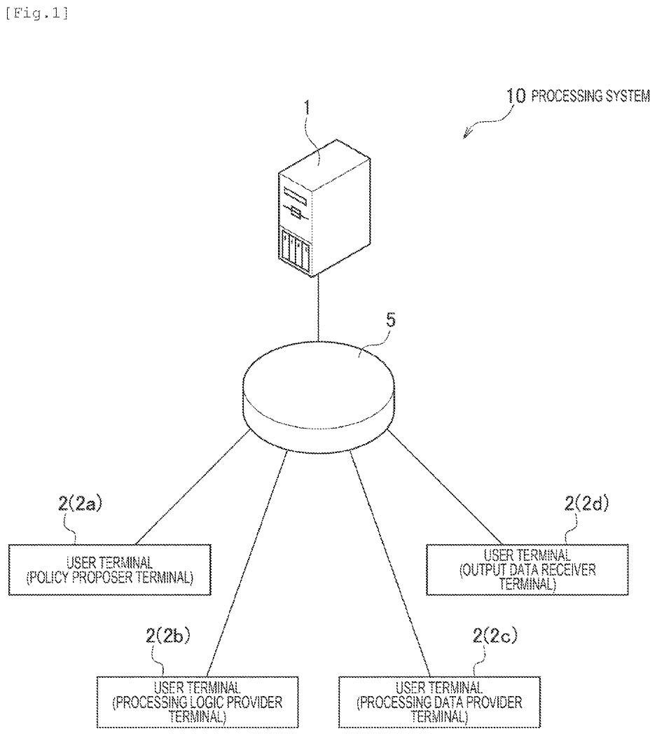

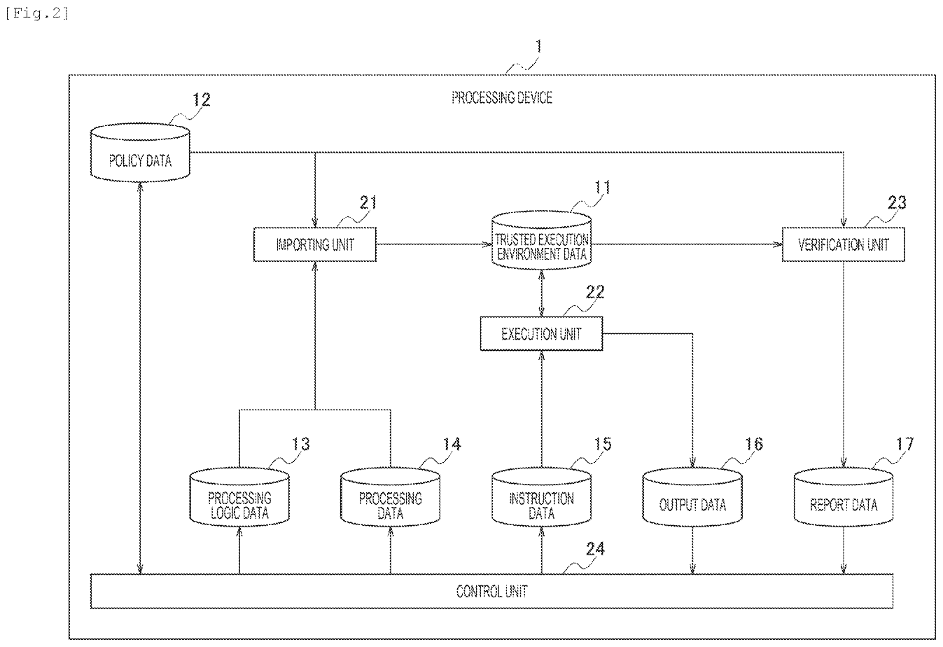

A processing system 10 illustrated in FIG. 1 includes a processing device 1 illustrated in FIG. 2 and a plurality of user terminals 2. The processing device 1 and the plurality of user terminals 2 are implemented by, for example, a general computer. The processing device 1 and the plurality of user terminals 2 are communicably connected to each other by a communication network 5.

The processing device 1 has a trusted execution environment (TEE). The processing system 10 imports processing logic data 13 and processing data 14 to the trusted execution environment generated in the processing device 1 according to policy data 12 provided by the user terminal 2, processes the processing data 14 using a program specified by the processing logic data 13, and outputs output data 16. The processing system 10 transmits the output data 16 to the user terminal 2 according to the policy data 12. At this point, according to the policy data 12, even after the trusted execution environment is generated, the processing device 1 verifies the trusted execution environment, the imported processing logic data 13, and the imported processing data 14; and verifies the trusted execution environment after processing by the processing logic data 13 and generates report data 17. The report data 17 is provided to the user terminal 2, and the user terminal 2 confirms that the trusted execution environment is an unaltered environment.

The user terminal 2 may be referred to as a policy proposer terminal 2a, a processing logic provider terminal 2b, a processing data provider terminal 2c, or an output data receiver terminal 2d depending on the role of a user. The policy proposer terminal 2a is used by a policy provider who proposes a policy to the processing device 1. The processing logic provider terminal 2b is used by a processing logic provider who provides the processing logic data 13 to the processing device 1. The processing data provider terminal 2c is used by a processing data provider who provides the processing data 14 to the processing device 1. The output data receiver terminal 2d instructs execution of processing of the processing data 14 according to the processing logic data 13, and is used by an output data receiver who receives the output data 16. The output data 16 is data obtained as a result of processing of the processing data 14 by the program specified by the processing logic data 13.

In the embodiment of the present invention, a case where a policy proposer, a processing logic provider, a processing data provider, and an output data receiver are different from each other will be described. However, the present invention is not limited thereto. For example, some users may take on multiple roles of a policy proposer, a processing logic provider, a processing data provider, and an output data receiver, such as a case where one user may be both a policy provider and an output data receiver and another user may be both a processing data provider and an output data receiver.

### (Processing Device)

As illustrated in FIG. 2, the processing device 1 includes pieces of data including trusted execution environment data 11, policy data 12, processing logic data 13, processing data 14, instruction data 15, output data 16, and report data 17, and has functions of an importing unit 21, an execution unit 22, a verification unit 23, and a control unit 24. The pieces of data are stored in a storage device such as a memory 902 or a storage 903. Each of the functions is implemented in a CPU 901.

The trusted execution environment data 11 is data for specifying a trusted execution environment (TEE) in a virtual machine (VM), a container, or the like that is protected by memory encryption or the like. One piece of trusted execution environment data 11 is generated for one piece of policy data 12 (one policy identifier).

The policy data 12 includes an identifier of the processing logic data, an identifier of the processing data, and a verification timing for specifying a necessity of verification before or after importing the processing logic data 13 or the processing data into the trusted execution environment or before execution of the processing logic data 13, and the like, the processing logic data and the processing data being pieces of data to be imported into the trusted execution environment. The policy data 12 may further define information for specifying a verification target. The policy data 12 may define a policy proposer, a processing logic provider, a processing data provider, and an output data receiver.

The policy data 12 may be data to which an electronic signature is assigned by each of a policy proposer, a processing logic provider, a processing data provider, and an output data receiver defined in the policy data 12. Thereby, alteration of the policy data 12 can be prevented.

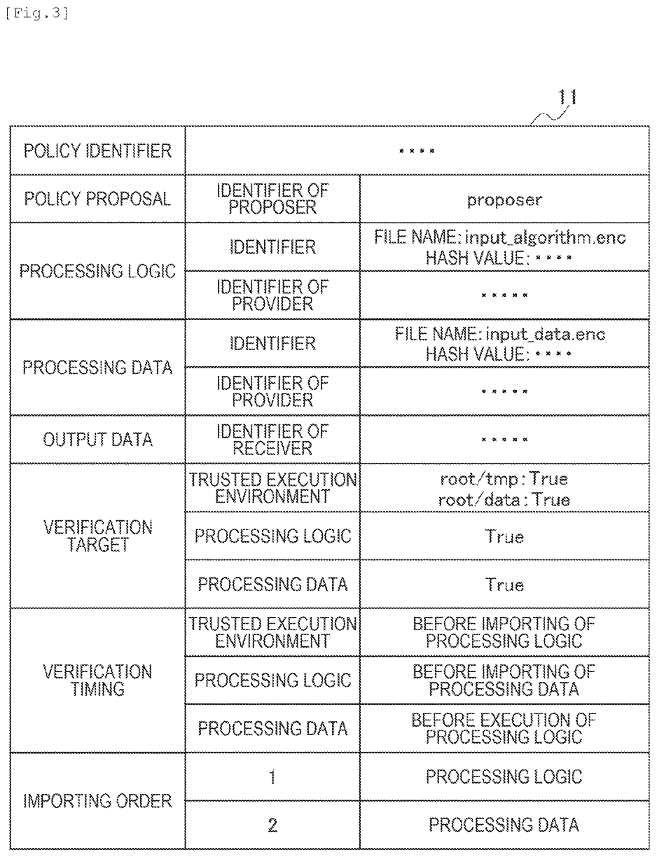

The policy data 12 is, for example, data illustrated in FIG. 3. The policy data 12 includes pieces of data related to a policy proposal, processing data, processing logic, output data, a verification target, a verification timing, and an importing order in association with an identifier of the policy.

The policy data 12 includes an identifier of the proposer for the policy proposal. The policy data 12 includes, for the processing logic, an identifier of the processing logic data 13 and an identifier of the processing logic provider. The identifier of the processing logic data 13 is, for example, a file name, a hash value, or the like, and uniquely identifies the processing logic data 13. The policy data 12 includes, for the processing data, an identifier of the processing data 14 and an identifier of the processing data provider. The identifier of the processing data 14 is, for example, a file name, a hash value, or the like, and uniquely identifies the processing data 14. The policy data 12 includes, for the output data 16, an identifier of the output data receiver.

In the policy data 12, for each of the users as the policy proposer, the processing logic provider, the processing data provider, and the output data receiver, in addition to the identifier, contact information such as an email address and attribute data such as an affiliation may also be included in association with each other.

In the policy data 12, as verification targets, an identifier of a folder that is a verification target of the trusted execution environment, a necessity of verification of the processing logic, and a necessity of verification of the processing data are associated with each other. In the example illustrated in FIG. 3, “True” means that verification is necessary, and “False” means that verification is unnecessary. The verification targets illustrated in FIG. 3 include a root/temp folder and a root/data folder of the trusted execution environment, the processing logic data 13, and the processing data 14. The verification target of the trusted execution environment is a part of a state before the processing logic data 13 or the processing data 14 is imported into the trusted execution environment, and is what is known as an operating system (OS) and a part related to the OS.

The policy data 12 defines, as a verification timing, a timing for verifying each target defined as the verification target. In the example illustrated in FIG. 3, the verification timing of the trusted execution environment is defined as “before importing of the processing logic”, the verification timing of the processing logic is defined as “before importing of the processing data”, and the verification timing of the processing data is defined as “before execution of the processing logic”. The verification timing is specified before or after an event in the trusted execution environment, such as before or after importing the processing logic data 13, before or after importing the processing data 14, and before or after processing of the processing data 14 by the processing logic data 13.

In the policy data 12 illustrated in FIG. 3, one verification timing is defined for each verification target. However, two or more verification timings may be defined for each verification target. For example, for the trusted execution environment, in addition to “before importing of the processing logic”, “before execution of the processing logic” may be further defined.

In the policy data 12, an import order may be optionally defined. The processing device 1 imports the processing logic data 13 and then imports the processing data 14 into the trusted execution environment by a default setting. In a case where an importing order is defined in the policy data 12, the processing device 1 imports the processing logic data 13 and the processing data 14 into the trusted execution environment according to the order defined in the policy data 12.

The processing logic data 13 is data for specifying a program to be executed in the trusted execution environment. The processing logic data 13 is provided by the processing logic provider terminal 2b. The processing logic data 13 may be in an encrypted state or in plain text.

The processing data 14 is data to be processed by the processing logic data 13 that is executed in the trusted execution environment. The processing data 14 is provided by the processing data provider terminal 2c. The processing data 14 may be in an encrypted state or in plain text.

The instruction data 15 is data for instructing execution of processing of the processing data 14 by the processing logic data 13 in the trusted execution environment. The instruction data 15 is input from the output data receiver terminal 2d.

The output data 16 is data of a processing result of the processing data 14 by the processing logic data 13 in the trusted execution environment. The output data 16 is provided to the output data receiver terminal 2d. The output data 16 may be in plain text, or may be in an encrypted state to be decryptable by the output data receiver terminal 2d.

The report data 17 is data of a verification result by the verification unit 23. The report data 17 is provided to a user who instructs importing of data or instructs execution of processing after the verification timing. Specifically, the report data 17 of the verification result before importing of the processing logic data 13 is provided to the processing logic provider terminal 2b. The report data 17 of the verification result before importing of the processing data 14 is provided to the processing data provider terminal 2c. The report data 17 of the verification result before execution of the processing logic is provided to the output data receiver terminal 2d that instructs execution of the processing.

In another example, the report data 17 may be provided after importing data or execution of processing.

For example, the report data 17 of the verification result after importing the processing logic data 13 may be provided to the processing logic provider terminal 2b. The report data 17 of the verification result after importing the processing data 14 may be provided to the processing data provider terminal 2c. The report data 17 of the verification result after execution of the processing logic may be provided to the output data receiver terminal 2d that instructs execution of the processing.

The report data 17 includes, for each verification timing, the verification result of the verification target at each verification timing. In the example illustrated in FIG. 3, the report data 17 of the verification result before importing of the processing logic data 13 includes verification results of the root/temp folder and the root/data folder of the trusted execution environment. The report data 17 of the verification result before importing of the processing data 14 includes the verification result of the processing logic data 13 that is imported to the trusted execution environment. The report data 17 of the verification result before execution of the processing logic includes the verification result of the processing data 14 that is imported into the trusted execution environment.

The report data 17 may include the presence of absence of alteration of the verification target. The report data 17 may further include data indicating a state of the trusted execution environment itself. In addition, the report data 17 may include a result of comparison with verification correct answer information for verification.

The importing unit 21 imports the processing logic data 13 and the processing data 14 into the trusted execution environment specified by the trusted execution environment data 11. At this time, the importing unit 21 refers to the policy data 12, and in a case where the importing order is not designated, imports the processing logic data 13 into the trusted execution environment, and then imports the processing data 14 into the trusted execution environment. In a case where the policy data 12 includes the importing order of the processing logic data 13 and the processing data 14, the importing unit 21 imports the processing logic data 13 and the processing data 14 into the trusted execution environment according to the importing order.

In principle, the importing unit 21 imports the processing logic data 13, and then imports the processing data 14. Thereby, even in a case where the processing logic data 13 is generated with malicious intent, the processing data 14 is prevented from being stolen or modified. Note that, in a case where it is defined in the policy data 12 that the processing data 14 is imported and then the processing logic data 13 is imported, the importing unit 21 imports the processing data 14 and the processing logic data 13 in this order according to the order defined in the policy data 12.

In a case where the processing logic data 13 or the processing data 14 to be imported is encrypted, the importing unit 21 decrypts the encrypted data with a common key or the like obtained by performing key exchange in advance or a decryption key, and imports the decrypted data.

In a case where the instruction data 15 is input, the execution unit 22 executes processing of the processing data 14 by the processing logic data 13 in the trusted execution environment. In addition, the execution unit 22 stores the output data 16 obtained by the processing.

The verification unit 23 refers to the policy data 12, verifies the verification target of the trusted execution environment at the timing specified by the verification timing, and outputs report data including the verification result. In the case of the policy data 12 illustrated in FIG. 3, the verification unit 23 verifies the root/temp folder and the root/data folder of the trusted execution environment before importing of the processing logic data 13, and generates report data 17 including the verification result. Before importing of the processing data 14, the verification unit 23 verifies the processing logic data 13 that is imported into the trusted execution environment, and generates the report data 17 including the verification result. Before execution of the processing logic, the verification unit 23 verifies the processing data 14 that is imported into the trusted execution environment, and generates the report data 17 including the verification result.

The verification unit 23 determines whether or not a difference between the hash value of the trusted execution environment data 11 of the trusted execution environment after generation of the trusted execution environment and the hash value of the trusted execution environment data 11 of the trusted execution environment at the verification timing is valid in consideration of an importing status of the processing logic data 13 or the processing data 14. In a case where the difference is valid, the verification unit 23 determines that there is no alteration. In a case where the difference is not valid, the verification unit 23 determines that there is an alteration. The verification unit 23 may generate the report data 17 including the determination result.

The verification unit 23 uses a list of unique information such as a directory configuration and a hash value of a file after generation of the trusted execution environment, as a determination criterion for the detection target specified by the policy data 12. The verification unit 23 specifies a difference between unique information such as a directory configuration and a hash value of a file at the verification timing and unique information such as a directory configuration and a hash value of a file after generation of the trusted execution environment. The difference is a change in a file or a directory in the trusted execution environment, specifically, addition, deletion, modification, or the like. Here, advanced intrusion detection environment (AIDE) or the like may be used to extract the difference.

Here, the determination criterion may include attribute information of a file or a folder in the trusted execution environment, such as an inode, and the attribute information is access information for the file or the folder or authority information for the file or the folder. By using the attribute information of the file or the folder as a determination criterion, even in a case where there is an unexpected access, a change in the authority information, or the like in the trusted execution environment, the verification unit 23 can detect an unexpected access, a change in the authority information, or the like.

The verification unit 23 may determine whether or not the specified difference is valid in comparison with the importing status of the processing logic data 13 or the processing data 14. The verification unit 23 may generate the report data 17 including a determination result as to whether or not the specified difference is valid.

Alternatively, the user terminal 2 may refer to the report data 17 including the specified difference, and compare the report data 17 with the importing status of the processing logic data 13 or the processing data 14 to determine whether or not the specified difference is valid. In addition, the user terminal 2 may display the report data 17 including the specified difference, and the user may compare the report data 17 with the importing status of the processing logic data 13 or the processing data 14 to determine whether the specified difference is valid.

At the timing of verification of the processing logic data 13, the verification unit 23 may determine that there is no alteration when the processing logic data 13 in a trusted verification environment matches with the hash value of the processing logic defined by the policy data 12, and may determine that there is an alteration when the processing logic data 13 in the trusted verification environment does not match with the hash value of the processing logic defined by the policy data 12. Similarly, at the timing of verification of the processing data 14, the verification unit 23 may determine that there is no alteration when the processing data 14 in the trusted verification environment matches with the hash value of the processing data defined by the policy data 12, and may determine that there is an alteration when the processing data 14 in the trusted verification environment does not match with the hash value of the processing data defined by the policy data 12. The verification unit 23 may generate the report data 17 including the determination result.

In addition to the verification target defined by the policy data 12, the verification unit 23 may verify the presence or absence of an alteration around a kernel in the trusted execution environment. The verification unit 23 verifies the presence or absence of an alteration around a kernel from comparison between verification correct answer information created in advance and information around the kernel at the timing of verification, and includes the verification result in the report data 17. The verification correct answer information is information for specifying an execution file, data (excluding the processing logic data 13 and the processing data 14 imported by the user), a kernel module, and the like in the kernel, and an image file used at a timing of generation of the trusted execution environment. The verification correct answer information is, for example, a hash value generated from the pieces of data. The execution file and data around the kernel are specifically ovmf, initrd, kernel-image, and kernel-cmdline.

In addition, the verification unit 23 may calculate data indicating a state of the trusted execution environment itself at the timing of verification, and include the data in the report data 17. The trusted execution environment itself is a portion corresponding to the kernel of the trusted execution environment, specifically, data indicating a state of the trusted execution environment from which the processing logic data 13 or the processing data 14 is excluded. The state of the trusted execution environment is, for example, a hash value of the trusted execution environment itself that is output by an attestation function of secure encrypted virtualization-secure nested paging (SEV-SNP). As long as there is no change in the data that indicates the state of the trusted execution environment and is included in the report data 17, the user can confirm that the trusted execution environment itself is not altered. In addition, the verification unit 23 may output the report data 17 using the attestation function.

The verification unit 23 may assign a signature using a signature key held by an EPYC chip, which is tamper-resistant hardware, to the report data 17 generated in this manner, and may output the report data 17 with the signature.

Further, the verification unit 23 may also output the output report data 17 as log data (not illustrated). Thereby, even after the verification, it is possible to confirm whether or not the trusted execution environment is altered, and further, in a case where the trusted execution environment is altered, it is possible to specify a timing when the trusted execution environment is altered in the past. In addition, the user terminal 2 can confirm the past report data 17 at an any timing.

The control unit 24 acquires the policy data 12 for which agreement of each user is obtained, and controls importing of the data to the trusted execution environment, verification of the trusted execution environment at the verification timing, and execution of processing of the processing data 14 using the processing logic data 13 according to the policy data 12.

The control unit 24 acquires the policy data 12 from the policy proposer terminal 2a, and stores the policy data 12 in a storage device. The control unit 24 may distribute the policy data 12 acquired from the policy proposer terminal 2a to each of the policy proposer, the processing logic provider, the processing data provider, and the output data receiver that are defined in the policy data 12, and assign an electronic signature of each user to the policy data 12.

The control unit 24 performs control such that the processing can proceed according to the definition of the policy data 12. The control unit 24 prompts the user terminal 2 to perform processing or transmits the report data 17 to the user terminal 2 so that importing of the data into the trusted execution environment, verification of the trusted execution environment, and execution of the processing logic are performed according to the policy data 12.

For example, the control unit 24 notifies the user terminal 2 of a uniform resource locator (URL) of an application programming interface (API) for providing the report data 17 at a timing when verification is performed with reference to the policy data 12. The control unit 24 stores the report data 17 in the URL to be notified to the user terminal 2. The user terminal 2 can refer to the report data 17 that is output by the verification unit 23 by accessing the notified URL.

In addition, in a case where the importing order is not defined in the policy data 12 or in a case where it is defined that the processing data 14 is imported after the processing logic data 13, the control unit 24 notifies the user terminal 2 (the processing logic provider terminal 2b) of the URL of the API for uploading the processing logic data 13, and notifies the user terminal 2 (the processing data provider terminal 2c) of the URL of the API for uploading the processing data 14 after the processing logic data 13 is imported to the trusted execution environment.

In a case where importing of the processing logic data 13 after importing the processing data 14 is defined in the policy data 12, the control unit 24 notifies the user terminal 2 (the processing data provider terminal 2c) of an URL of an API for uploading the processing data 14, and notifies the user terminal 2 (the processing logic provider terminal 2b) of an URL of an API for uploading the processing logic data 13 after the processing data 14 is imported into the trusted execution environment. The control unit 24 stores the data uploaded through the notified URL in the processing device 1, and causes the importing unit 21 to import the data into the trusted execution environment.

After the user terminal 2 that accesses the notified URL is authenticated, the control unit 24 may permit the user terminal 2 to upload or download data.

Here, a case where the processing device 1 and the user terminal 2 transmit and receive data via the API has been described, but the present invention is not limited thereto. Transmission and reception of data may be performed between the processing device 1 and the user terminal 2 by using an e-mail, a message, or the like.

### (Processing Method)

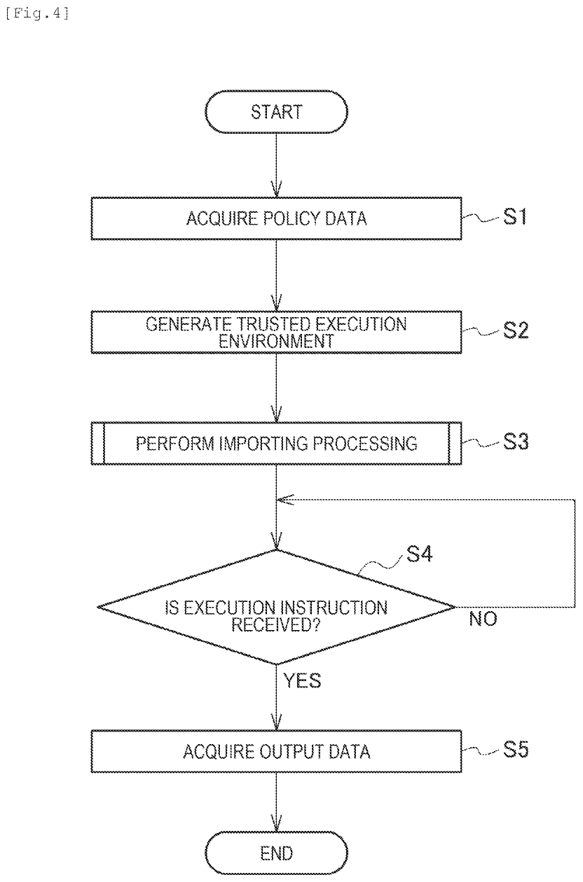

A processing method in the processing device 1 according to the embodiment will be described with reference to FIG. 4. The verification processing by the verification unit 23 is performed according to the definition of the policy data 12. Thus, in FIG. 4, description excluding the processing of the verification unit 23 will be given.

First, in step S1, the control unit 24 acquires the policy data 12, and stores the policy data 12 in the processing device 1. In step S2, the processing device 1 generates a trusted execution environment.

In step 83, the importing unit 21 performs importing processing of the processing logic data 13 and the processing data 14 that are provided by the user terminal 2. After the processing logic data 13 and the processing data 14 are imported into the trusted execution environment, in step S4, the control unit 24 waits for an instruction to execute processing of the processing data 14 using the processing logic data 13, from the user terminal 2.

When the control unit 24 receives an instruction for execution in step S4, in step S5, the execution unit 22 executes processing of the processing data 14 using the processing logic data 13 in the trusted execution environment, and outputs the output data 16. The control unit 24 provides the output data 16 to the user terminal 2.

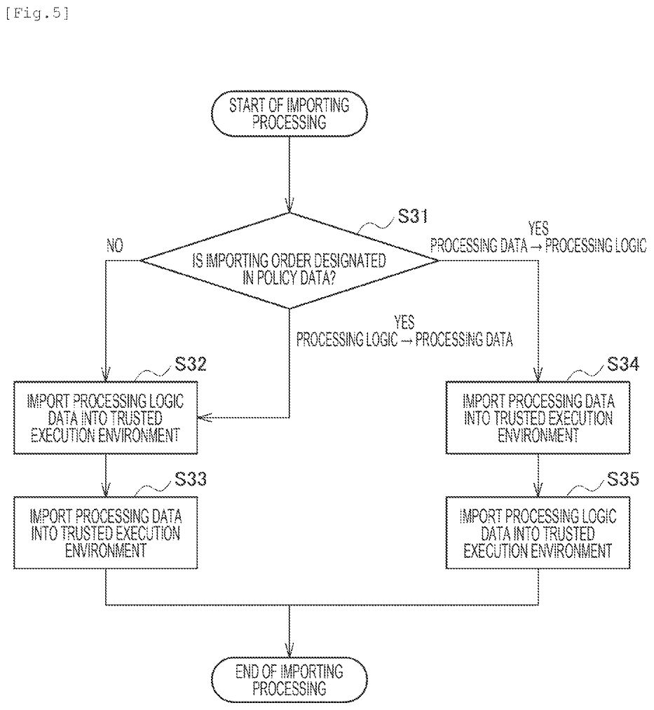

The importing processing in step S3 of FIG. 4 will be described with reference to FIG. 5.

In step S31, the importing unit 21 determines whether or not an importing order is designated in the policy data 12. In a case where an importing order is not designated, or in a case where an importing order for importing the processing data 14 after importing the processing logic data 13 is designated, the process proceeds to step S32.

In step 832, the importing unit 21 imports the processing logic data 13 into the trusted execution environment. In step S33, the importing unit 21 imports the processing data 14 into the trusted execution environment.

In a case where an importing order for importing the processing logic data 13 after importing the processing data 14 is designated in the policy data 12, the process proceeds to step S34. In step S34, the importing unit 21 imports the processing data 14 into the trusted execution environment. In step S35, the importing unit 21 imports the processing logic data 13 into the trusted execution environment.

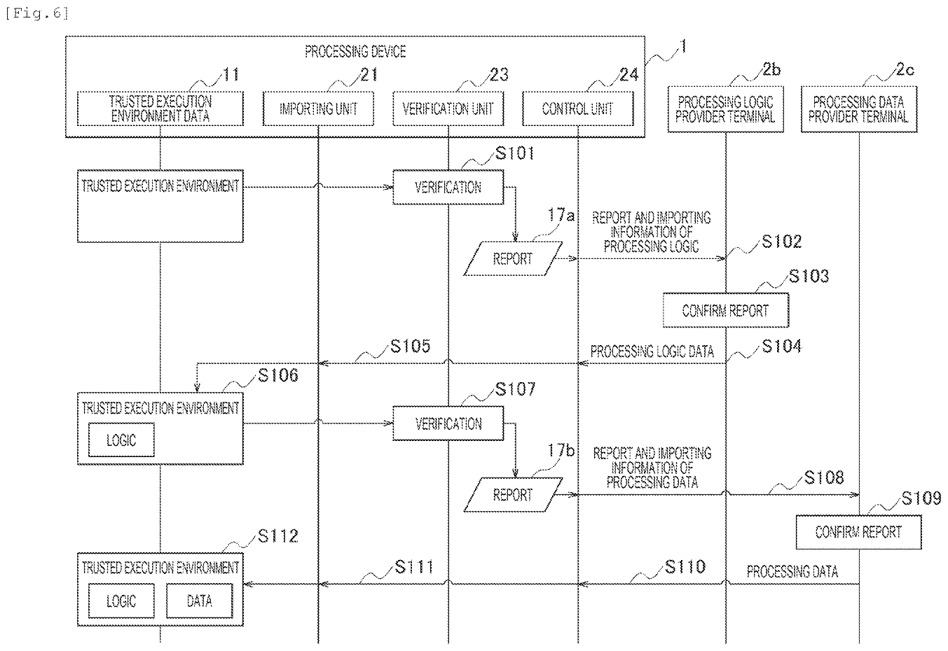

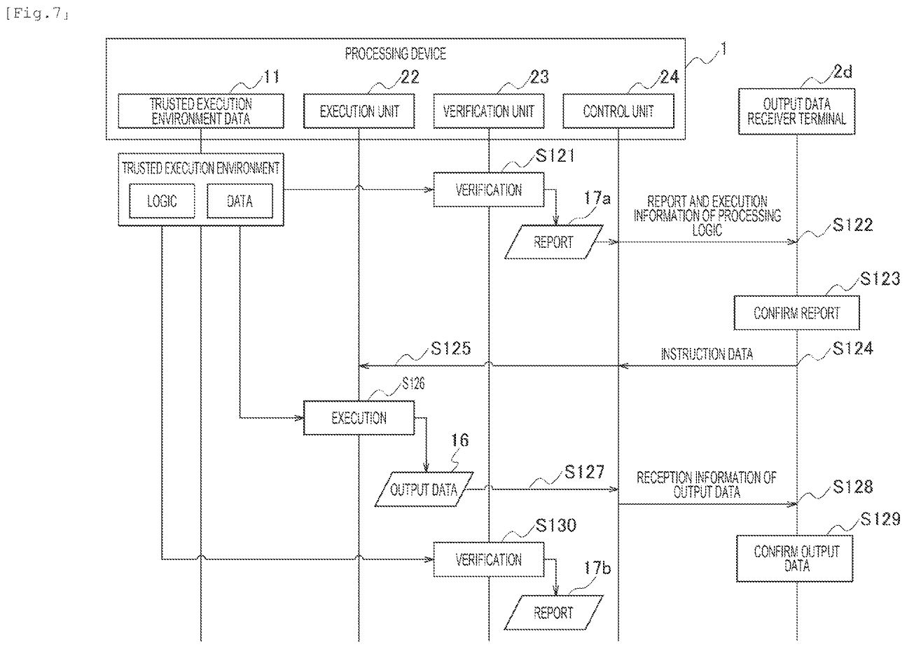

An example of using the processing device 1 after the trusted execution environment is generated will be described with reference to FIG. 6 and FIG. 7. Here, a case where the processing device 1 operates according to the verification target, the verification timing, and the importing order indicated by the policy data of FIG. 3 will be described.

Specifically, the verification targets are a designated folder in the trusted execution environment, the processing logic data 13, and the processing data. In the importing order, the first is the processing logic data 13, and the second is the processing data 14. The verification timing of the trusted execution environment is before importing of the processing logic data 13. The verification timing of the processing logic data 13 is before importing of the processing data 14. The verification timing of the processing data 14 is before execution of processing of the processing data 14 using the processing logic data 13.

### (Importing Processing of Processing Logic Data 13)

After the trusted execution environment is generated, in step S101, the verification unit 23 verifies the trusted execution environment, and generates the report data 17a before importing the processing logic data 13. The verification unit 23 specifies a difference between unique information such as a directory configuration and a hash value of a file in the trusted execution environment at the timing, and unique information such as a directory configuration and a hash value of a file immediately after generation of the trusted execution environment. In addition, the verification unit 23 verifies the presence or absence of alteration from the verification correct answer information and the current status around the kernel. The verification unit 23 generates the report data 17a from the specified difference and the verification result of the presence or absence of alteration based on the current situation around the kernel.

In step S102, the control unit 24 transmits the generated report data 17a and information for importing the processing logic data 13 to the processing logic provider terminal 2b. The information for importing the processing logic data 13 includes an URL of an API of an importing destination, an URL of a user authentication system for importing, and the like.

In step S103, the processing logic provider terminal 2b acquires the report data 17a and the importing information of the processing logic data 13, and confirms the report data 17a. The processing logic provider terminal 2b confirms whether there is no alteration in the trusted execution environment and around the kernel, from the report data 17a. Specifically, the processing logic provider terminal 2b confirms whether there is no difference between the current trusted execution environment and the state immediately after generation of the trusted execution environment. The processing logic provider terminal 2b confirms whether there is no alteration around the kernel of the current trusted execution environment.

In step S104, the processing logic provider terminal 2b accesses the URL of the user authentication system for importing, and performs authentication. Then, the processing logic provider terminal 2b accesses the URL of the API of the importing destination, and uploads the processing logic data 13.

In step S105, when the uploading of the processing logic data 13 is detected, the control unit 24 stores the processing logic data 13 in the processing device 1. In step S106, the importing unit 21 imports the processing logic data 13 into the trusted execution environment. The importing of the processing logic data 13 is completed.

### (Importing Processing of Processing Data 14)

Before importing the processing data 14, in step S107, the verification unit 23 verifies the processing logic data 13 of the trusted execution environment, and generates the report data 17b. The verification unit 23 specifies a difference between unique information such as a directory configuration and a hash value of a file in the trusted execution environment at the timing, and unique information such as a directory configuration and a hash value of a file immediately after generation of the trusted execution environment. In addition, the verification unit 23 verifies the presence or absence of alteration based on the verification correct answer information and the current status around the kernel. The verification unit 23 generates the report data 17b from the specified difference and the verification result of the presence or absence of alteration in the current situation around the kernel.

In step S108, the control unit 24 transmits the generated report data 17b and information for importing the processing data 14 to the processing data provider terminal 2c. The information for importing the processing data 14 includes an URL of an API of an importing destination, an URL of a user authentication system for importing, and the like.

In step S109, the processing data provider terminal 2c acquires the report data 17b and the importing information of the processing data 14, and confirms the report data 17b. The processing data provider terminal 2c confirms whether there is no alteration in the trusted execution environment and around the kernel, from the report data 17b. Specifically, the processing data provider terminal 2c confirms that the difference between the current trusted execution environment and the state immediately after generation of the trusted execution environment is due to the importing of the processing logic data 13. The processing data provider terminal 2c confirms whether there is no alteration around the kernel of the current trusted execution environment.

In step S110, the processing data provider terminal 2c accesses the URL of the user authentication system for importing, and performs authentication. Then, the processing data provider terminal 2c accesses the URL of the API of the importing destination, and uploads the processing data 14.

In step S111, when the uploading of the processing data 14 is detected, the control unit 24 stores the processing data 14 in the processing device 1. In step S112, the importing unit 21 imports the processing data 14 into the trusted execution environment. The import of the processing data 14 is completed.

### (Execution of Processing Logic Data 13)

Before execution of the processing data 14 by the processing logic data 13, in step S121, the verification unit 23 verifies the processing data 14 of the trusted execution environment, and generates the report data 17c.

The verification unit 23 specifies a difference between unique information such as a directory configuration and a hash value of a file in the trusted execution environment at the timing, and unique information such as a directory configuration and a hash value of a file immediately after generation of the trusted execution environment. In addition, the verification unit 23 verifies the presence of absence of alteration from the verification correct answer information and the current status around the kernel. The verification unit 23 generates the report data 17c from the specified difference and the verification result of the presence or absence of alteration based on the current situation around the kernel.

In step S122, the control unit 24 transmits the generated report data 17c and information for executing the processing logic data 13 to the output data receiver terminal 2d. The information for executing the processing logic data 13 includes an URL of an API that inputs an execution instruction, an URL of a user authentication system for input, and the like.

In step S123, the output data receiver terminal 2d acquires the report data 17c and information for execution of the processing logic data 13, and confirms the report data 17c. The output data receiver terminal 2d confirms whether there is no alteration in the trusted execution environment and around the kernel, from the report data 17c. Specifically, the output data receiver terminal 2d confirms that the difference between the current trusted execution environment and the state immediately after generation of the trusted execution environment is due to the importing of the processing logic data 13 and the processing data 14. The output data receiver terminal 2d confirms whether there is no alteration around the kernel of the current trusted execution environment.

In step S124, the output data receiver terminal 2d accesses the URL of the user authentication system for input, and performs authentication. Then, the output data receiver terminal 2d accesses the URL of the API for inputting of an execution instruction, and inputs instruction data.

In step S125, in a case where an input of the instruction data 15 is detected, the control unit 24 stores the instruction data 15 in the processing device 1. In step S126, the execution unit 22 processes the processing data 14 in the trusted execution environment by the processing logic data 13, and stores the output data 16 in the processing device 1.

When storing of the output data 16 is detected in step S127, in step S128, the control unit 24 transmits information for receiving the output data 16 to the output data receiver terminal 2d. The information for receiving the output data 16 includes an URL of an API for receiving the output data 16, an URL of a user authentication system for reception, and the like. The output data receiver terminal 2d acquires information for receiving the output data 16. The output data receiver terminal 2d accesses the URL of the user authentication system for reception, and performs authentication. Then, the output data receiver terminal 2d accesses the URL of the API for receiving the output data 16, and acquires the output data 16. In step S129, the output data receiver terminal 2d confirms the output data 16.

After processing is executed in the trusted execution environment by the execution unit 22, in step S130, the verification unit 23 verifies the trusted execution environment, and generates the report data 17d.

The verification unit 23 specifies a difference between unique information such as a directory configuration and a hash value of a file in the trusted execution environment at the timing, and unique information such as a directory configuration and a hash value of a file immediately after generation of the trusted execution environment. In addition, the verification unit 23 verifies the presence or absence of alteration from the verification correct answer information and the current status around the kernel. The verification unit 23 generates the report data 17d from the specified difference and the verification result of the presence or absence of alteration based on the current situation around the kernel. The report data 17d may be provided to the output data receiver terminal 2d together with the output data 16.

In a series of processes in which the processing logic data 13 and the processing data 14 are imported into the trusted execution environment and the processing is executed in the trusted execution environment, the processing device 1 according to the embodiment verifies the trusted execution environment, and generates the report data 17. The user can confirm that the environment is a trusted execution environment without alteration, and then instruct importing of data or execution of processing.

Even after the trusted execution environment is generated, the processing device 1 can ensure the trusted execution environment without alteration, and can ensure the integrity of the processing logic data 13 and the processing data 14. Thus, it is possible to resolve concerns of the user and contribute to distribution of data.

In addition, the verification timing, the verification target, and the like can be determined by the user by using the policy data 12. The processing device 1 can realize verification that meets the needs of the user.

The processing device 1 generates the report data 17 including the verification result of the verification target designated at the verification timing, as the report data 17. The user can confirm that the trusted execution environment is clean with minimum information, and thus, a burden on the user is reduced.

As the processing device 1 according to the present embodiment described above, for example, a general-purpose computer system including the central processing unit (CPU, processor) 901, the memory 902, the storage 903 (a hard disk drive (HDD), a solid state drive (SSD)), a communication device 904, an input device 905, and an output device 906 is used. In the computer system, each function of the processing device 1 is implemented by the CPU 901 executing a program loaded on the memory 902.

Note that the processing device 1 may be implemented by one computer, or may be implemented by a plurality of computers. In addition, the processing device 1 may be a virtual machine that is implemented on a computer.

The program of the processing device 1 can be stored in a computer-readable recording medium such as an HDD, an SSD, a universal serial bus (USB) memory, a compact disc (CD), or a digital versatile disc (DVD), or can be distributed via a network. The computer-readable recording medium is, for example, a non-transitory recording medium.

Note that the present disclosure is not limited to the above embodiment, and various modifications can be made within the scope of the spirit of the present invention.

### REFERENCE SIGNS LIST

1 Processing device
2 User terminal
2a Policy proposer terminal
2b Processing logic provider terminal
2c Processing data provider terminal
2d Output data receiver terminal
5 Communication network
10 Processing system
11 Trusted execution environment data
12 Policy data
13 Processing logic data
14 Processing data
15 Instruction data
16 Output data
17 Report data
21 Importing unit
22 Execution unit
23 Verification unit
24 Control unit
901 CPU
902 Memory
903 Storage
904 Communication device
905 Input device
906 Output device

1. A processing device comprising:
a storage device configured to store policy data including an identifier of processing logic data and an identifier of processing data, and a verification timing for specifying a necessity of verification before or after importing the processing logic data or the processing data into a trusted execution environment or before execution of the processing logic data; and
one or more processors configured to:
import the processing logic data and the processing data into the trusted execution environment; and
verify the trusted execution environment at a timing specified as the verification timing by referring to the policy data, and output report data including a verification result.

2. The processing device according to claim 1,
wherein the one or more processors are configured to import the processing logic data and then import the processing data, and
in a case where the policy data includes an importing order of the processing logic data and the processing data, the one or more processors are configured to import the processing logic data and the processing data according to the importing order.

3. The processing device according to claim 1,
wherein the one or more processors are configured to extract a difference between a status of the trusted execution environment at a timing specified by the verification timing and a status at a timing of generation of the trusted execution environment by referring to the policy data, and include the extracted difference in the report data.

4. The processing device according to claim 1,
wherein the one or more processors are configured to determine whether or not a difference between a hash value of data included in the trusted execution environment after generation of the trusted execution environment and a hash value of data included in the trusted execution environment at the verification timing is valid in consideration of an importing status of the processing logic data or the processing data.

5. The processing device according to claim 1, wherein the one or more processors are configured to notify a user terminal of an URL of an API for providing the report data at a timing when verification is performed with reference to the policy data.

6. The processing device according to claim 2, wherein the one or more processors are configured to notify a user terminal of an URL of an API for uploading the processing logic data and notify a user terminal of an URL of an API for uploading the processing data after the processing logic data is imported.

7. A processing method comprising:
storing policy data including an identifier of processing logic data and an identifier of processing data, and a verification timing for specifying a necessity of verification before or after importing of the processing logic data or the processing data into a trusted execution environment or before execution of the processing logic data,
importing the processing logic data and the processing data into the trusted execution environment; and
verifying the trusted execution environment at a timing specified as the verification timing by referring to the policy data, and output report data including a verification result.

8. A recording non-transitory computer readable medium storing a program processing program, where the program causes one or more computers to perform operations as a processing device, wherein the processing device comprises:
a storage device configured to store policy data including an identifier of processing logic data and an identifier of processing data, and a verification timing for specifying a necessity of verification before or after importing the processing logic data or the processing data into a trusted execution environment or before execution of the processing logic data; and
one or more processors configured to:
import the processing logic data and the processing data into the trusted execution environment; and
verify the trusted execution environment at a timing specified as the verification timing by referring to the policy data, and output report data including a verification result.
